(19) United States
(12) Patent Application Publication
(10) Pub. No.: US 2017/0279166 A1
(43) Pub. Date: Sep. 28, 2017

(54) Lithium-Ion Cell

(71) Applicant: Bayerische Motoren Werke Aktiengesellschaft, Muenchen (DE)

(72) Inventors: Nikolaos TSIOUVARAS, Muenchen (DE); Jan Philipp SCHMIDT, Muenchen (DE)

(21) Appl. No.: 15/618,363

(22) Filed: Jun. 9, 2017

Related U.S. Application Data
(63) Continuation of application No. PCT/EP2015/077343, filed on Nov. 23, 2015.

(30) Foreign Application Priority Data
Dec. 10, 2014 (DE) 10 2014 225 452.3

(51) Int. Cl. H01M 10/48; H01M 4/131; H01M 10/04; H01M 2/16; H01M 4/66; H01M 10/0525; H01M 4/38

(52) U.S. Cl. CPC H01M 10/48; H01M 10/0525; H01M 4/131; H01M 4/382; H01M 2/1686; H01M 4/66; H01M 10/0445; H01M 2220/20

(57) ABSTRACT

A lithium-ion cell includes two working electrodes which are located opposite one another and have different polarities and between which a separator which electrically insulates the working electrodes with respect to one another and is permeable to lithium ions is arranged in an electrolyte space. A lithium-containing reservoir electrode is in contact with the electrolyte space in such a way that electronic isolation is provided and lithium ions are exchanged, wherein by way of a measuring and control circuit which connects the reservoir electrode to at least one of the working electrodes a voltage can be measured between the reservoir electrode and the working electrode and a voltage can be applied between the reservoir electrode and the working electrode. The reservoir electrode is of porous design and is arranged between two insulation layers of the separator which provide electronic isolation and are permeable to lithium ions.

### CROSS REFERENCE TO RELATED APPLICATIONS

This application is a continuation of PCT International Application No. PCT/EP2015/077343, filed Nov. 23, 2015, which claims priority under 35 U.S.C. §119 from German Patent Application No. 10 2014 225 452.3, filed Dec. 10, 2014, the entire disclosures of which are herein expressly incorporated by reference.

### BACKGROUND AND SUMMARY OF THE INVENTION

The invention relates to a lithium-ion cell having two working electrodes which are situated opposite one another and which have different polarities. Between the working electrodes a separator, which electronically insulates the working electrodes from one another and is permeable to lithium ions, is arranged in an electrolyte space. A lithium-containing reservoir electrode is in contact with the electrolyte space such that electronic insulation is provided and lithium ions are exchanged. Via a measuring and control circuit which connects the reservoir electrode to at least one of the working electrodes, a voltage can be measured between the reservoir electrode and the working electrode and also a voltage can be applied between the reservoir electrode and the working electrode.

Lithium-ion cells of this kind are known from U.S. Pat. No, 7,726,975 B2.

Lithium-ion cells are known as modern high-power energy stores for electronic devices and also for motor vehicles with a purely electric or hybrid drive. The advantages of the lithium-ion cells, of which the operating principle is based on the migration of lithium ions between the two working electrodes in an electrolyte which, itself, is not involved in the electrochemical reactions at the working electrodes, are primarily the high energy density and the ability to withstand a very large number of charging and discharging cycles. The typical design of a lithium-ion cell includes two working electrodes which are suitable for binding or intercalating lithium ions.

In order to prevent an electronic short-circuit between the working electrodes, a so-called separator is arranged in the electrolyte space which is situated between the working electrodes and is filled with an electrolyte and, on the one hand, provides electronic insulation between the working electrodes but, on the other hand, can allow lithium ions to pass. The passage of ion currents of this kind with a high density is required in order to allow a correspondingly high battery current. The separator is typically constructed in a single layer or multiple layers from a porous, electrically insulating polymer material, for example from polyethylene or polypropylene or a mixture thereof, wherein the porosity is such that the migration of lithium ions is restricted only slightly as far as possible.

It has been found that lithium-ion cells are subject to a not inconsiderable loss of capacity over their service life, with this effect being more pronounced in an early stage of the service life of the lithium-ion cell than in a later stage. The main cause of this loss of capacity is the formation of a lithium-containing intermediate layer between the negative electrode and the electrolyte, said intermediate layer also being known as the Solid Electrolyte Interface (SEI) to a person skilled in the art. This intermediate layer stores lithium ions which are then no longer available for the electrochemical process. Various parasitic reactions which “consume” lithium, which is then no longer available for cell operation, are also known.

The abovementioned document which establishes the generic type of lithium-ion cells discloses coupling a reservoir electrode to the electrolyte space by way of a dedicated separator perpendicular to the two working electrodes and the separator. This reservoir electrode performs two tasks. First, the reservoir electrode can be used as a reference electrode of which the voltage difference in relation to the working electrodes can be measured by way of a measuring and control circuit. A person skilled in the art can use the voltage difference to draw conclusions about the state of charge of the cell, in particular about the current and potential binding or intercalation capacity for lithium ions at the working electrodes. As a result, it is possible, in particular, to further establish whether and to what extent lithium which was originally present in the cell is removed from the electrochemical process, it being possible to ascribe this, in particular, to the effects outlined above. By applying a suitable voltage between the reservoir electrode and a working electrode, an electronic current can then be generated from the reservoir electrode, by way of the measuring and control circuit, to the working electrode as a countermeasure. The electronic current results in an ionic current from the reservoir electrode, by way of the separator thereof, to the working electrode. In other words, lithium ions are introduced into the electrolyte space from the reservoir electrode. The lithium ions are then available for further electrochemical reactions and it is possible to replace the lithium which is bound in the SEI or consumed by parasitic reactions. The service life of the lithium-ion cell is considerably extended in this way.

One disadvantage of this known approach is the unfortunate spatial configuration of the reservoir electrode in relation to the working electrodes, which makes compact construction of lithium-ion cells difficult in common formats. In particular, the design of a lithium-ion cell in the conventional stacked or spiral arrangement would lead to the reservoir electrode, which is arranged perpendicular in relation to the working electrodes having to be designed to be very small. This is associated with a correspondingly low storage capacity for reservoir lithium.

The object of the present invention is to develop a lithium-ion cell of the generic type in such a way that a large reservoir capacity for reservoir lithium is available even in the case of common cell arrangements.

This and other objects are achieved by a lithium-ion cell comprising two working electrodes which are situated opposite one another and have different polarities and between which a separator which electronically insulates the working electrodes from one another and is permeable to lithium ions is arranged in an electrolyte space. A lithium-containing reservoir electrode is in contact with the electrolyte space such that electronic insulation is provided and lithium ions are exchanged. By way of a measuring and control circuit which connects the reservoir electrode to at least one of the working electrodes, a voltage can be measured between the reservoir electrode and the working electrode and also a voltage can be applied between the reservoir electrode and the working electrode. The reservoir electrode is of porous design and is arranged between two insulation layers, which provide electronic insulation and are permeable to lithium ions, of the separator.

According to the invention, the reservoir electrode is integrated into the separator between the working electrodes. In other words, the separator is functionalized firstly as a reservoir electrode and secondly as a reference electrode between the working electrodes.

As outlined above, it is critical for the performance of a lithium-ion cell for the ion current to be able to flow between the working electrodes in an unimpeded manner as far as possible. This objective is readily achieved by way of conventional separators which are composed of porous insulation layers. The invention now makes provision for the separator to be formed from a plurality of insulation layers of this kind, between which a porous reservoir layer, which likewise does not impede the ion current, is embedded. This reservoir layer makes no contribution to the primary effect of the separator, specifically that of ionically permeable and electronically insulating isolation of the working electrodes. This is not necessary either since this task is performed in an established manner by the insulation layers. The reservoir layer merely provides lithium and must not additionally impede the ion current, this being made possible on account of its (sufficiently large) porosity. Therefore, approximately the same surface area is available for the reservoir electrode as for each working electrode, and therefore a considerable quantity of reservoir lithium can be stored here, it being possible for said reservoir lithium to be delivered subsequently, in principle in a known manner, over the service life of the cell in order to replace lost lithium. Accordingly, the total service life of the lithium-ion cell according to the invention is also extended in comparison to the prior art.

It goes without saying that it is necessary for the reservoir electrode as a whole to be electrically conductive, so that functional connection to the measuring and control circuit is possible. To this end, it has proven to be particularly advantageous when the reservoir electrode comprises an electrically conductive polymer material to which a lithium-containing application material is applied. Suitable electrically conductive polymer materials are, for example, polyaniline, polypyrrole or polythiophene, which are preferably used individually or in a mixture here. The lithium-containing application material used may be, for example, lithium iron phosphate (LiFePO₄). This material may be present, in particular, in the form of nanoparticles with which the conductive polymer layer can be coated or which can be embedded in the conductive polymer layer. LiFePO₄ is of particular interest for use within the scope of the present invention owing to its property of providing a constant voltage over a wide operating range (lithium concentration range). However, one disadvantage of LiFePO₄ is its comparatively low energy density. In this respect, conventional lithium metal oxides, such as NMC (lithium nickel manganese cobalt oxide) for example, would be preferred on account of their higher energy density. Lithium metal has the highest energy density, but cannot be processed in oxygen; however, if it is processed in an inert gas atmosphere, it can of course be used within the scope of the present invention.

The specific application method for applying the lithium-containing application material to the conductive polymer layer is of secondary importance in the present invention. By way of example, vapor deposition, spraying, melting and other methods are known to a person skilled in the art in addition to the abovementioned embedding of nanoparticles in this respect.

In addition to the application materials, all materials which contain lithium in such a way that lithium ions can be discharged into the electrolyte space by applying a voltage between the reservoir electrode and one of the working electrodes are suitable in principle. These materials also include, in particular, metallic lithium.

The polymer material of the reservoir electrode and/or the insulation layers are preferably used in the form of porous membranes. Porous membranes of this kind can be in the form of stretched films for example. Pores of a readily adjustable size can be generated in the film owing to the mechanical stress which is applied when stretching a film.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a schematic illustration of a lithium-ion cell according to an embodiment of the invention.

### DETAILED DESCRIPTION OF THE DRAWING

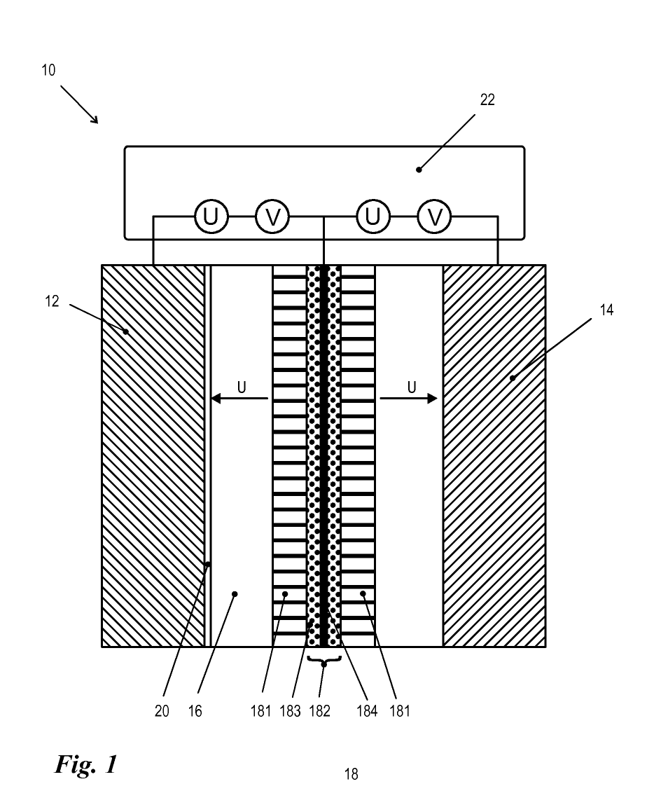

FIG. 1 is a schematic illustration of a lithium-ion cell 10 according to an embodiment of the invention. The cell 10 has a first, negative working electrode 12 and a second, positive working electrode 14. An electrolyte space 16 which is filled with an electrolyte which, in particular, also impregnates the working electrodes 12, 14, is located between the working electrodes 12, 14. A separator 18 is arranged in the electrolyte space 16, the primary task of said separator being that of electronically insulating the working electrodes 12, 14 from one another and, at the same time, allowing lithium ions to flow through the electrolyte space 16. The working electrodes 12, 14 are formed from materials which allow reversible binding or intercalation of lithium ions which can move freely in the electrolyte. An extremely wide variety of materials of which the different properties have an effect on the operating properties of the cell 10 are known to a person skilled in the art in this respect.

As outlined in the introductory part, an intermediate layer 20 can be deposited between the first electrode 12 and the electrolyte space 16 during operation of the cell 10, in particular during the first charging and discharging cycles of said cell, wherein lithium ions accumulate in the layer 20 and are withdrawn from the electrochemical process.

The separator 18 is designed in a particular way in order to replace lithium ions which are lost in such a way or in some other way. For example, in the illustrated exemplary embodiment, the separator 18 comprises two outer insulation layers 181 which are preferably composed of a polymer which provides electrical insulation and is permeable to lithium ions, in particular polyethylene or polypropylene. In this case, the insulation layers 181 are preferably in the form of stretched films. The insulation layers 181 electronically isolate the working electrodes 12, 14.

A reservoir electrode 182 is arranged between the insulation layers 181. The reservoir electrode 182 is in the form of an electrically conductive polymer layer 183 in which a lithium-containing application material 184 is embedded in the illustrated embodiment. By way of example, the lithium-containing application material 184 is composed of lithium iron phosphate, for example in the form of embedded nanoparticles.

The reservoir electrode 182 is connected to the working electrodes 12, 14 by way of a measuring and control circuit 22. The measuring and control circuit 22 is designed such that it can be used to measure a voltage between the reservoir electrode 182 and one of the working electrodes 12, 14, indicated by the voltmeter symbol “V”. In addition, it is possible to apply a voltage U between the reservoir electrode 18 and one of the working electrodes 12, 14 by way of the measuring and control circuit 22. As a result, an electron current which runs across the measuring and control circuit 22 from the reservoir electrode 18 to one of the working electrodes 12, 14 can be triggered, this resulting in a corresponding lithium ion current from the reservoir electrode 18 into the electrolyte space 16. Lithium which is stored in the intermediate layer 20 can be replaced in this way. The level and duration of the voltage required for this purpose can be determined on the basis of a preceding voltage measurement between the reservoir electrode 18 and the working electrodes 12, 14, wherein the reservoir electrode 18 serves as a reference electrode in this case.

It goes without saying that the embodiments which are discussed in the specific description and shown in the figures are only illustrative exemplary embodiments of the present invention. In light of the present disclosure, a person skilled in the art is provided with a broad spectrum of possible variations. In particular, a person skilled in the art can of course vary the specific design of the reservoir electrode. For example, embodiments in which an electrically conductive carrier material is coated with the lithium-containing application material only on one side are also feasible.

### LIST OF REFERENCE SYMBOLS

10 Lithium-ion cell
12 First working electrode
14 Second working electrode
16 Electrolyte space
18 Separator
181 Insulation layer
182 Reservoir electrode
183 Electrically conductive polymer layer
184 Lithium-containing application material
20 Intermediate layer
22 Measuring and control circuit

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A lithium-ion cell comprising:
two working electrodes situated opposite one another and having different polarities;
a separator arranged in an electrolyte space between the two working electrodes, the separator electronically insulating the two working electrodes from one another and being permeable to lithium ions;
a lithium-containing reservoir electrode in contact with the electrolyte space such that electronic insulation is provided and lithium ions are exchanged;
a measuring and control circuit connecting the reservoir electrode to at least one of the two working electrodes, wherein a voltage is measurable between the reservoir electrode and the at least one working electrode and further wherein a voltage is appliable between the reservoir electrode and the at least one working electrode, wherein
the separator comprises two insulation layers that provide electronic insulation and are permeable to lithium ions, and
the reservoir electrode has a porous design and is arranged between the two insulation layers of the separator.

2. The lithium-ion cell according to claim 1, wherein
the reservoir electrode comprises an electrically conductive polymer material to which a lithium-containing application material is applied.

3. The lithium-ion cell according to claim 2, wherein
the electrically conductive polymer material comprises a polyaniline, a polypyrrole, or a polythiophene.

4. The lithium-ion cell according to claim 3, wherein
the lithium-containing application material comprises lithium iron phosphate (LiFePO₄).

5. The lithium-ion cell according to claim 2, wherein
the lithium-containing application material comprises lithium iron phosphate (LiFePO₄).

6. The lithium-ion cell according to claim 2, wherein the lithium-containing application material comprises metallic lithium.

7. The lithium-ion cell according to claim 3, wherein the lithium-containing application material comprises metallic lithium.

8. The lithium-ion cell according to claim 1, wherein the two insulation layers of the separator comprise polyethylene or polypropylene.

9. The lithium-ion cell according to claim 2, wherein the two insulation layers of the separator comprise polyethylene or polypropylene.

10. The lithium-ion cell according to claim 2, wherein
the polymer material of the reservoir electrode is in a form of a porous membrane.

11. The lithium-ion cell according to claim 10, wherein polymer materials of the two insulation layers are in a form of porous membranes.

12. The lithium-ion cell according to claim 2, wherein polymer materials of the two insulation layers are in a form of porous membranes.

13. The lithium-ion cell according to claim 2, wherein the polymer material of the reservoir electrode is in a form of a stretched film.

14. The lithium-ion cell according to claim 13, wherein polymer material of the two insulation layers are in a form of stretched films.

15. The lithium-ion cell according to claim 2, wherein polymer material of the two insulation layers are in a form of stretched films.
